(19) United States
(12) Patent Application Publication
(10) Pub. No.: US 2021/0390601 A1
(43) Pub. Date: Dec. 16, 2021

(54) SHOPPING SUPPORT DEVICE, SHOPPING SUPPORT SYSTEM, SHOPPING SUPPORT METHOD, AND SHOPPING SUPPORT PROGRAM

(71) Applicant: TOYOTA JIDOSHA KABUSHIKI KAISHA, Toyota-shi (JP)

(72) Inventor: Shoji ITOH, Nagoya-shi (JP)

(73) Assignee: TOYOTA JIDOSHA KABUSHIKI KAISHA, Toyota-shi (JP)

(21) Appl. No.: 17/209,837

(22) Filed: Mar. 23, 2021

(30) Foreign Application Priority Data
Jun. 16, 2020 (JP) 2020-103871

(51) Int. Cl. G06Q 30/06; G06Q 10/08; H04N 7/04; H04L 29/06

(52) U.S. Cl. CPC G06Q 30/0613; G06Q 30/0633; G06Q 30/0643; G06Q 20/203; H04N 7/04; H04L 65/60; G06Q 10/083

(57) ABSTRACT

By transmitting shopping support selection screen information for displaying a shopping support selection screen to a client terminal, the shopping support selection screen that preferentially displays a shopping method using “shopping agency service” and “shopping list” is displayed on the client terminal. When “shopping agency service” is selected, a shopping agency process is performed, and when “shopping list” is selected, a shopping list process is performed.

### CROSS-REFERENCE TO RELATED APPLICATION

This application claims priority to Japanese Patent Application No. 2020-103871 filed on Jun. 16, 2020, incorporated herein by reference in its entirety.

### BACKGROUND

### 1. Technical Field

The present disclosure relates to a shopping support device, a shopping support system, a shopping support method, and a shopping support program that support shopping of a user.

### 2. Description of Related Art

Japanese Unexamined Patent Application Publication No. 2015-135557 (JP 2015-135557 A) proposes a privilege information processing system that promotes sales to customers who are likely to consider purchasing products. Specifically, the system acquires the browsing history information of the website in the online shopping service, extracts the browsing history information based on the user ID and the product ID included in the acquired browsing history information, quantifies the browsing act based on the details of the act indicated by the extracted browsing history information by referring to the point DB in which the numerical value corresponding to the browsing act is set, and generates the information to notify the privilege given to the user in the online shopping service based on the quantified browsing act.

### SUMMARY

However, online shopping services such as those described in JP 2015-135557 A may be shunned by users who are not accustomed to operating website screens. In particular, there is room for improvement for users such as the elderly because they may not be accustomed to normal online shopping where shopping is performed while searching for products on the website screen.

However, especially for users such as the elderly, the products they often purchase may be fixed for many years, and optimized shopping support has not been provided to such users.

The present disclosure has been made in consideration of the above facts, and the purpose of the present disclosure is to provide a shopping support device, a shopping support system, a shopping support method, and a shopping support program that are optimized for users who are unfamiliar with normal online shopping on a website screen or who have a fixed number of products that they often purchase for many years.

In order to achieve the above purpose, a shopping support device according to claim 1 includes: a display processing unit that performs a process of preferentially displaying a first shopping method using streaming distribution and a second shopping method using a shopping list generated from a purchase history of a user from among a plurality of shopping methods; and a processing unit that performs a process of streaming distributing an image of a product candidate to the user and receiving a purchase instruction from the user when the first shopping method displayed by the display processing unit is selected, and that performs a process of receiving a purchase instruction for a product selected from the shopping list when the second shopping method is selected.

According to the disclosure described in claim 1, a process of preferentially displaying a first shopping method using streaming distribution and a second shopping method using a shopping list generated from a purchase history of a user from among a plurality of shopping methods is performed.

In the processing unit, a process of streaming distributing an image of a product candidate to the user and receiving a purchase instruction from the user when the first shopping method displayed by the display processing unit is selected, and a process of receiving a purchase instruction for a product selected from the shopping list when the second shopping method is selected are performed. That is, the user can select whether to shop by streaming using a shopping agency service or shop using a shopping list. As a result, it is possible to provide an optimized shopping support device to users who are unfamiliar with normal online shopping on a website screen or who have a fixed number of products that they often purchase for many years.

As in the disclosure described in claim 2, the display processing unit may display two options of the first shopping method and the second shopping method. That is, by preferentially displaying the first shopping method and the second shopping method, it is possible to suppress the confusion of the user by displaying more information than necessary.

As in the disclosure described in claim 3, when the display processing unit performs display after the user browses a notification related to a product from a store, the display processing unit may perform a process of preferentially displaying the first shopping method over the second shopping method. When a user browses notifications from a store, the user is likely to be interested in products other than those in the shopping list, and is more likely to select the first shopping method. Thus, it is possible to save the trouble of the user who selects the first shopping method.

As in the disclosure described in claim 4, the processing unit may receive delivery information for delivery to the user, and further perform a process related to arrangement of the delivery to the user. This makes it possible to deliver the product to the user.

As in the disclosure described in claim 5, the disclosure may be applied to a shopping support system including: the shopping support device according to any one of claims 1 to 4; a client terminal for the user to shop, the client terminal including an operation unit for operation of selecting the first shopping method or the second shopping method and a display unit for performing display by the display processing unit; a shopping agent terminal for a shopping agent to perform shopping on behalf of the user, the shopping agent terminal including an imaging unit for capturing an image for the streaming distribution and a voice input and output unit for talking with the user; and a delivery management device that manages the delivery of a product subjected to the purchase instruction received by the shopping support device.

As in the disclosure described in claim 6, the disclosure may be applied to a shopping support method executed by a computer, the shopping support method including: preferentially displaying a first shopping method using streaming distribution and a second shopping method using a shopping list generated from a purchase history of a user from among a plurality of shopping methods; performing a process of streaming distributing an image of a product candidate to the user and receiving a purchase instruction from the user when the displayed first shopping method is selected; and performing a process of receiving the purchase instruction of a product selected from the shopping list when the second shopping method is selected.

As in the disclosure described in claim 7, the disclosure may be applied to a shopping support program for causing a computer to function as each unit of the shopping support device according to any one of claims 1 to 4.

As described above, the present disclosure has an effect that can provide a shopping support device, a shopping support system, a shopping support method, and a shopping support program that are optimized for users who are unfamiliar with normal online shopping on a website screen or who have a fixed number of products that they often purchase for many years.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a shopping support system according to the present embodiment;

FIG. 2 is a block diagram showing a main configuration of an electrical system of a shopping support server, a product management server, a delivery management server, a shopping terminal, and a shopping agency operator terminal;

FIG. 3 is a diagram showing an initial screen, a shopping item selection screen, and a store selection screen as examples of screens displayed by a support application pre-installed on a client terminal;

FIG. 4 is a diagram showing a shopping support selection screen, a streaming screen, a shopping list usage selection screen, and a shopping list screen as examples of screens displayed when shopping at each store;

FIG. 5 is a diagram showing a payment screen and a delivery screen as examples of screens displayed when “Proceed to checkout” is selected on the streaming screen or the shopping list screen;

FIG. 6 is a flowchart showing an example of a processing flow performed by the shopping support server of the shopping support system according to the present embodiment;

FIG. 7 is a flowchart showing an example of a processing flow performed by the client terminal of the shopping support system according to the present embodiment; and

FIG. 8 is a flowchart showing a modified example of a processing flow performed by the shopping support server of the shopping support system according to the present embodiment.

### DETAILED DESCRIPTION OF EMBODIMENTS

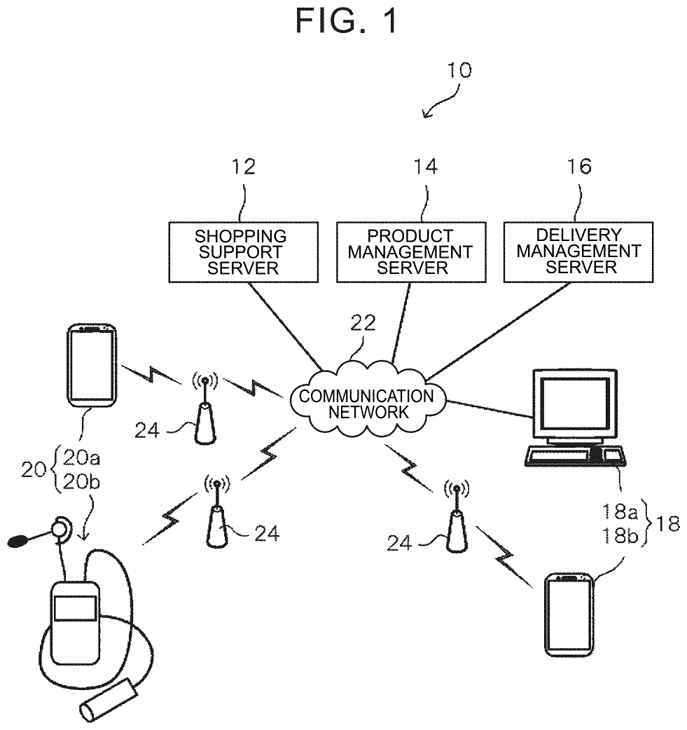

Hereinafter, an example of the embodiment of the present disclosure will be described in detail with reference to the drawings. FIG. 1 is a diagram showing a schematic configuration of a shopping support system 10 according to the present embodiment.

As shown in FIG. 1, the shopping support system 10 according to the present embodiment includes a shopping support server 12 as a shopping support device, a product management server 14, a delivery management server 16 as a delivery management device, a client terminal 18, and a shopping agency operator terminal 20 as a terminal for a shopping agent, and each of the above components is connected to a communication network 22.

The shopping support server 12 provides a service that supports a user's shopping at a pre-registered store. In the present embodiment, as an example, services such as a shopping agency service through real-time streaming distribution and a service that provides a shopping list generated including a user's past purchase history, special sale items, and the like are provided as shopping support.

The product management server 14 has a database function for accumulating information such as product information and a user's purchase history, and provides the accumulated information when providing shopping support. In addition, the product management server 14 has a function of managing products by using a well-known technique such as a point of sale (POS) system.

The delivery management server 16 makes delivery arrangements for products purchased using the service provided by the shopping support server 12.

The client terminal 18 functions as an interface for accessing the shopping support server 12 and receiving the service provided by the shopping support server 12. As the client terminal 18, for example, as shown in FIG. 1, a personal computer 18a may be applied, a mobile terminal 18b such as a smartphone may be applied, or an Internet television or the like may be applied. When the mobile terminal 18b is applied, the mobile terminal 18b is connected to the communication network 22 via a wireless relay station 24 or the like.

The shopping agency operator terminal 20 has a function of capturing a streaming video when performing a shopping agency service provided by the shopping support server 12 and a function of talking with a user. The shopping agency operator terminal 20 is connected to the communication network 22 via the wireless relay station 24. Further, as the shopping agency operator terminal 20, for example, as shown in FIG. 1, a mobile terminal 20a such as a smartphone may be applied, or a wearable terminal 20b including a headset and a camera may be applied.

Various networks such as local area network (LAN), wide area network (WAN), the Internet, and an intranet are applied to the communication network 22, and various data are transmitted and received between connected devices.

Next, the main configuration of the electrical system of the shopping support server 12, the product management server 14, the delivery management server 16, the client terminal 18, and the shopping agency operator terminal 20 in the shopping support system 10 according to the present embodiment will be described.

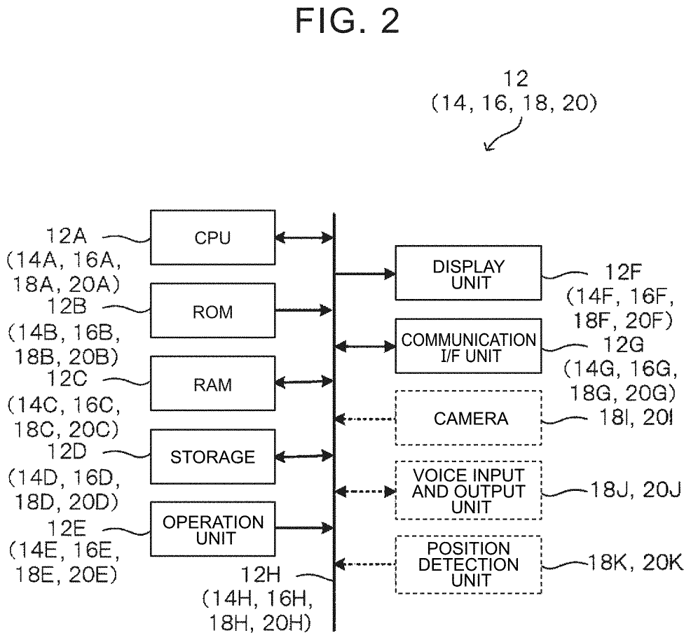

FIG. 2 is a block diagram showing the main configuration of the electrical system of the shopping support server 12, the product management server 14, the delivery management server 16, the client terminal 18, and the shopping agency operator terminal 20. Since the shopping support server 12, the product management server 14, the delivery management server 16, the client terminal 18, and the shopping agency operator terminal 20 basically have a general configuration of a computer, the shopping support server 12 will be described here as a representative example.

As shown in FIG. 2, the shopping support server 12 includes a central processing unit (CPU) 12A, a read only memory (ROM) 12B, a random access memory (RAM) 12C, a storage 12D, an operation unit 12E, a display unit 12F, and a communication interface (I/F) unit 12G.

The CPU 12A is a central arithmetic processing unit that functions as a display processing unit and a processing unit, and controls the overall operation of the device by executing various programs. Various control programs, various parameters, and the like are stored in advance in the ROM 12B. The RAM 12C is used as a work area or the like when the CPU 12A executes various programs. The storage 12D is composed of various storage units such as a hard disk drive (HDD), a solid state drive (SSD), and a flash memory, and stores various data, application programs, and the like. The operation unit 12E includes a keyboard, a mouse, a touch panel, and the like, and is used for inputting various types of information. The display unit 12F is used to display various types of information. The communication I/F unit 12G can be connected to the communication network 22 of various networks such as LAN, WAN, and the Internet, and transmits and receives various data to and from other devices connected to the communication network 22. Each of the above components of the shopping support server 12 is electrically connected to each other by a system bus 12H.

With the above configuration, the shopping support server 12 uses the CPU 12A to access the ROM 12B, the RAM 12C, and the storage 12D, acquire various data via the operation unit 12E, and display various types of information on the display unit 12F. Further, the shopping support server 12 executes control of transmission/reception of communication data via the communication I/F unit 12G by the CPU 12A.

The client terminal 18 and the shopping agency operator terminal 20 further include, as shown by the dotted lines in FIG. 2, cameras 18I and 20I as imaging units, voice input and output units 18J and 20J, position detection units 18K and 20K, and the like.

The cameras 18I and 20I generate image data representing a moving image or a still image by capturing a still image or a moving image. In the shopping agency operator terminal 20 of the present embodiment, the images captured by the cameras 18I and 20I are streamed to the client terminal 18 in real time.

The voice input and output units 18J and 20J output voice from a speaker, headphones, or the like, collect the sound with a microphone or the like to input the voice, and generate voice information representing the input voice. In the present embodiment, the voice input and output units 18J and 20J enable conversation between the shopping agency operator and the user.

The position detection units 18K and 20K detect the current position information of the client terminal 18 and the shopping agency operator terminal 20. For example, the position is detected by receiving radio waves from global positioning system (GPS) satellites and positioning the position of one point in a space based on the distances from three or more GPS satellites.

Subsequently, a service provided by the shopping support server 12 of the shopping support system 10 according to the present embodiment configured as described above will be described with reference to specific examples.

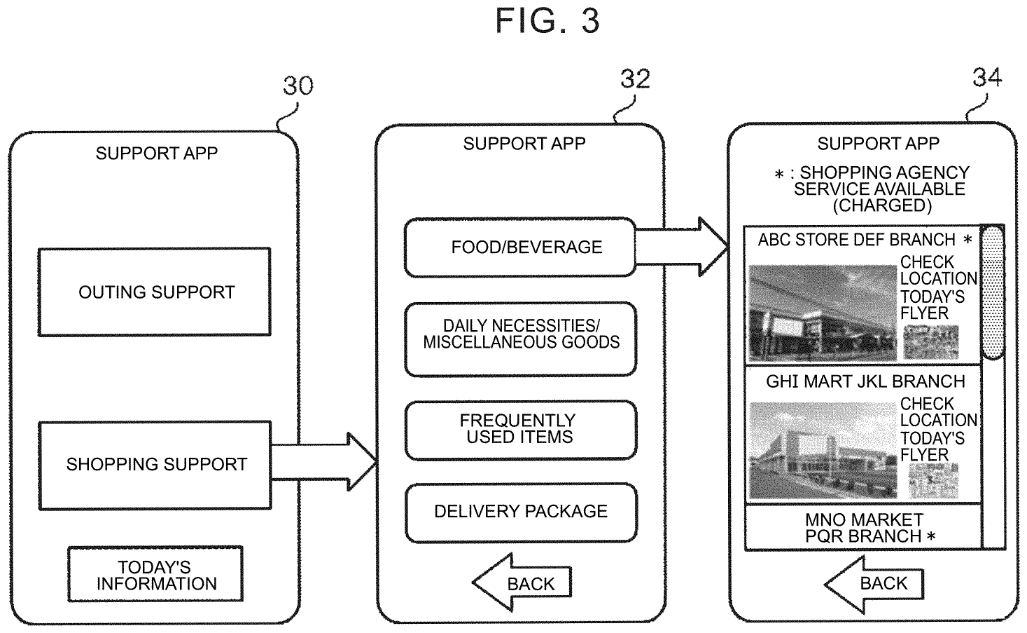

FIG. 3 is a diagram showing an initial screen, a shopping item selection screen, and a store selection screen as examples of screens displayed by a support application pre-installed on the client terminal 18. Hereinafter, the support application may be referred to as a support app. The following describes screen examples when the client terminal 18 is a mobile terminal 18b such as a smartphone, and in each subsequent screen example, the buttons on the screen displayed on the display unit 18F are operated by operating the operation unit 18E of the mobile terminal 18b.

When the support app is started on the client terminal 18, the initial screen 30 shown in FIG. 3 is displayed. In the example of FIG. 3, the initial screen 30 displays selection buttons for selecting “Outing support”, “Shopping support”, “Today's information”, and the like.

When “Shopping support” on the initial screen 30 is selected, a shopping item selection screen 32 is displayed. In the example of FIG. 3, the shopping item selection screen 32 displays selection buttons for selecting “Food/beverage”, “Daily necessities/miscellaneous goods”, “Frequently used items”, “Delivery package”, and the like. In addition, a “Back” button is displayed on the shopping item selection screen 32, and when the “Back” button is selected, the screen returns to the initial screen 30.

When “Food/beverage” on the shopping item selection screen 32 is selected, a store selection screen 34 is displayed. In the example of FIG. 3, the store selection screen 34 displays selection items for selecting “ABC Store DEF Branch”, “GHI Mart JKL Branch”, “MNO Market PQR Branch”, and the like. In the selection items, in the example of FIG. 3, a link to “Today's flyer” is displayed, and when “Today's flyer” is selected, store advertisement information can be displayed as recommended information. Each displayed store is a pre-registered store. In addition, a mark (“*” in FIG. 3) that can distinguish stores where shopping agency services are available is displayed. Further, a “Back” button is displayed on the store selection screen 34, and when the “Back” button is selected, the screen returns to the shopping item selection screen 32. Alternatively, the screen may return to the initial screen 30.

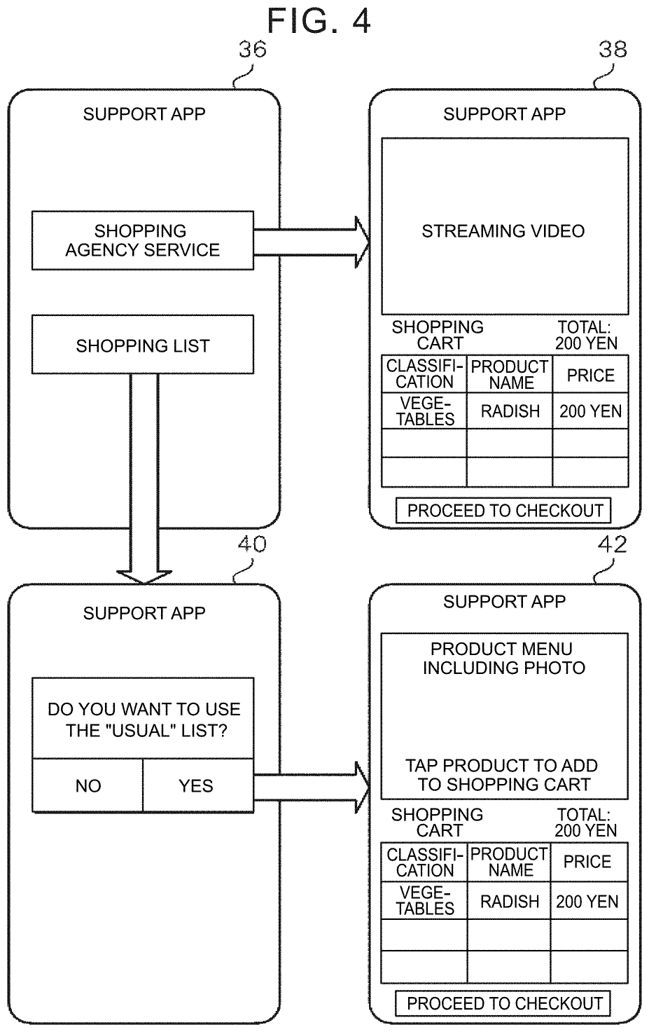

Next, various screens displayed when a store where the shopping agency service is available is selected on the store selection screen 34 will be described. FIG. 4 is a diagram showing a shopping support selection screen, a streaming screen, a shopping list usage selection screen, and a shopping list screen as examples of screens displayed when shopping at each store.

When a store where the shopping agency service is available is selected on the store selection screen 34, the shopping support selection screen 36 is displayed. On the shopping support selection screen 36, selection buttons for selecting “Shopping agency service” and “Shopping list” are displayed. In this way, in the present embodiment, the two selection buttons of the shopping method using the “Shopping agency service” and the shopping method using the “Shopping list” are preferentially displayed, which can suppress confusion of the user due to displaying more information than necessary. In the present embodiment, as an example of preferentially displaying two selection buttons, an example of displaying only two selection buttons is shown, but the present disclosure is not limited to this, and other selection buttons can be displayed by scrolling. As an example of another selection button, as in general online shopping, a normal purchase button or the like that displays product items in a predetermined order to select a purchase target may be displayed.

The streaming screen 38 is a screen in which the shopping agency operator streams the video captured by the shopping agency operator terminal 20 in real time to perform shopping while talking with the shopping agency operator. In the example of FIG. 4, the streaming video, the total price of the shopping cart, the classification, the product name, and the price of the selected products, the “Proceed to checkout” button for payment, and the like are displayed on the streaming screen 38. On the streaming screen 38, for example, the user instructs the operator by talking with the operator to perform pseudo shopping. When the target product is determined, the shopping agency operator operates the shopping agency operator terminal 20 to register the target product as a shopping target, so that the product is added to the shopping cart on the streaming screen 38 of FIG. 4. The addition to the shopping cart may be performed by operating the operation unit 20E, or by reading a barcode or the like of a product with the camera 20I or the like.

On the other hand, when the “Shopping list” is selected on the shopping support selection screen 36, the shopping list usage selection screen 40 is displayed. The shopping list usage selection screen 40 is a screen for selecting whether to perform shopping using the “usual” list as the shopping list generated from the user's past purchase history. As shown in FIG. 4, a message confirming the approval (Do you want to use the “usual” list?) and a button for selecting “Yes” or “No” are displayed.

When “Yes” is selected on the shopping list usage selection screen 40, the shopping list screen 42 is displayed. In the example of FIG. 4, the product menu of the shopping list including photos, the total price of the shopping cart, the classification, the product name, and the price of the selected products, the “Proceed to checkout” button for payment, and the like are displayed on the shopping list screen 42.

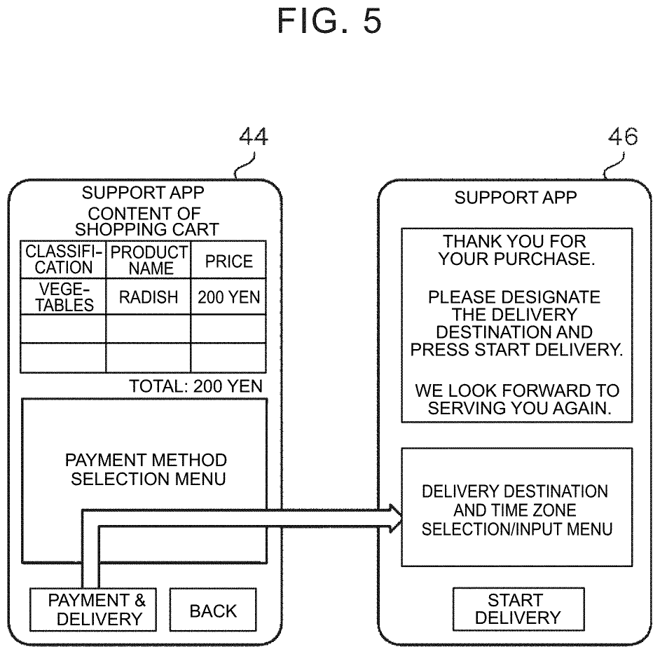

Next, various screens displayed when “Proceed to checkout” is selected on the streaming screen 38 or the shopping list screen 42 will be described. FIG. 5 is a diagram showing a payment screen and a delivery screen as examples of screens displayed when “Proceed to checkout” is selected on the streaming screen 38 or the shopping list screen 42.

On the payment screen 44, the classification, the product name, the price, and the total price of the product selected as the content of the shopping cart, and a menu for selecting a payment method are displayed. As a menu for selecting a payment method, various payment methods such as credit card payment and transfer are displayed as an example. In addition, buttons such as “Payment & delivery” and “Back” are displayed on the payment screen 44.

When “Payment & delivery” is selected on the payment screen 44, the delivery screen 46 is displayed. On the delivery screen 46, a message from the store (in the example shown in FIG. 5, “Thank you for your purchase. Please designate the delivery destination and press start delivery. We look forward to serving you again.”) is displayed. Further, on the delivery screen 46, a menu for selecting and inputting a delivery destination, a time zone, and the like is displayed, and a “Start delivery” button is displayed. Here, the shopping ends when the delivery destination and the time zone are designated and “Start delivery” is selected. Delivery of the purchased product is arranged by the delivery management server 16.

Subsequently, a specific processing performed by the shopping support system 10 according to the present embodiment configured as described above will be described.

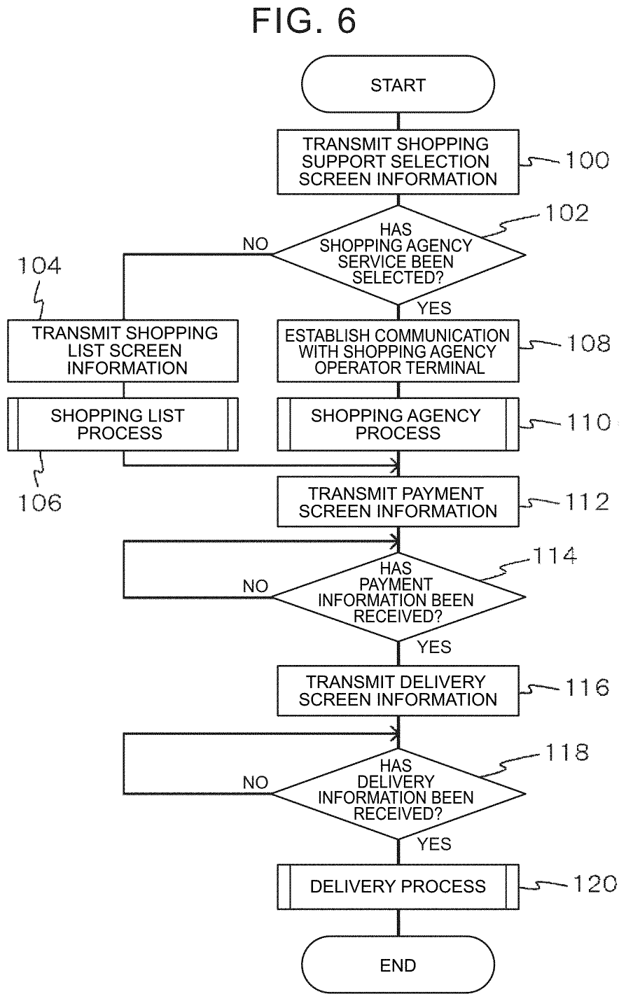

FIG. 6 is a flowchart showing an example of a processing flow performed by the shopping support server 12 of the shopping support system 10 according to the present embodiment. In the present embodiment, the process of FIG. 6 is started when a store where the shopping agency service is available is selected on the store selection screen 34 described above, but the present disclosure is not limited to this, and for example, the process of FIG. 6 may be started when the support app is started and the menu is displayed.

In step 100, the CPU 12A transmits the shopping support selection screen information for displaying the shopping support selection screen 36 to the client terminal 18, and proceeds to step 102. Accordingly, the shopping support selection screen 36 that preferentially displays the shopping method using the “Shopping agency service” and the “Shopping list” is displayed on the client terminal 18. Note that step 100 corresponds to the display processing unit, and subsequent steps 102 to 120 correspond to the processing unit.

In step 102, the CPU 12A determines whether the shopping agency service has been selected. In the determination, whether an operation of selecting the “Shopping agency service” on the shopping support selection screen 36 is performed by the client terminal 18 and the shopping agency selection information is transmitted from the client terminal 18 is determined. When the shopping agency service has not been selected, the process proceeds to step 104, and when the shopping agency service has been selected, the process proceeds to step 108.

In step 104, the CPU 12A transmits the shopping list screen information for displaying the shopping list screen 42 to the client terminal 18, and proceeds to step 106. That is, the shopping list screen information for displaying the shopping list screen 42 is generated and transmitted to the client terminal 18. Although the case where the above-mentioned shopping list usage selection screen 40 is omitted will be described here, the process of step 104 may be performed when the shopping list usage selection screen information for displaying the shopping list usage selection screen 40 is transmitted to the client terminal 18 and the use of the shopping list is selected. The shopping list displayed on the shopping list screen 42 is created based on the user's past purchase history accumulated in the product management server 14. For example, a shopping list is created by extracting products purchased at a predetermined frequency. Alternatively, a shopping list may be created by performing machine learning using the past purchase history to extract items that the user may purchase.

In step 106, the CPU 12A performs a shopping list process and proceeds to step 112. In the shopping list process, a process of providing shopping support using the shopping list to the client terminal 18 is executed. For example, an operation on the shopping list screen 42 is received from the client terminal 18. Specifically, the information such as the classification, the product name, and the price of the product to be purchased designated by the operation of the client terminal 18 is acquired from the product management server 14, and the process of generating the information to be displayed as the shopping cart on the shopping list screen 42 and transmitting the information to the client terminal 18 is performed. The shopping list process proceeds to step 112 when the operation of selecting “Proceed to checkout” on the shopping list screen 42 is performed by the client terminal 18.

On the other hand, in step 108, the CPU 12A establishes communication with the shopping agency operator terminal 20 and proceeds to step 110. Accordingly, the video captured by the shopping agency operator terminal 20 is distributed to the client terminal 18, which enables shopping by talking.

In step 110, the CPU 12A performs a shopping agency process and proceeds to step 112. In the shopping agency process, the shopping agency operator performs a process of performing shopping on behalf of the user while transmitting the streaming video to the client terminal 18 and talking. For example, in the shopping agency process, a process of generating streaming screen information for displaying the streaming screen 38 and transmitting the information to the client terminal 18 is performed. In addition, a process of distributing to the client terminal 18 a video of acquiring a product to be purchased designated by the user by talking is performed. Further, the product to be purchased is received from the shopping agency operator terminal 20, and the product classification, the product name, the price, and the like are acquired from the product management server 14. Then, a process of generating information to be displayed as the shopping cart on the streaming screen 38 and transmitting the information to the client terminal 18 is performed. The shopping agency process proceeds to step 112 when the operation of selecting “Proceed to checkout” on the streaming screen 38 is performed by the client terminal 18.

In step 112, the CPU 12A transmits the payment screen information for displaying the payment screen 44 to the client terminal 18, and proceeds to step 114. Accordingly, the payment screen 44 shown in FIG. 5 is displayed on the client terminal 18.

In step 114, the CPU 12A determines whether the payment information has been received. In the determination, it is determined whether the payment information indicating the payment method selected from the payment method selection menu displayed on the payment screen 44 has been received from the client terminal 18. The process waits until the CPU 12A determines that the payment information has been received and proceeds to step 116.

In step 116, the CPU 12A transmits the delivery screen information for displaying the delivery screen 46 to the client terminal 18, and proceeds to step 118. Accordingly, the delivery screen 46 shown in FIG. 5 is displayed on the client terminal 18.

In step 118, it is determined whether the delivery information has been received. In the determination, it is determined whether the delivery information indicating the delivery destination, the time zone, and the like input to the delivery destination and time zone selection/input menu displayed on the delivery screen 46 has been received from the client terminal 18. The process waits until it is determined that the delivery information has been received and proceeds to step 120.

In step 120, the CPU 12A performs a delivery process for delivering the product to be purchased and ends the series of processes. In the delivery process, a process related to arrangement for shipping the product instructed to be purchased to the user using the “Shopping agency service” or the “Shopping list”. For example, in the delivery process, the delivery of the purchased product is arranged by transferring the delivery information indicating the delivery destination, the time zone, and the like received from the client terminal 18 to the delivery management server 16. Accordingly, the delivery management server 16 notifies the delivery person such as the delivery company of the delivery information, so that the delivery person can receive the product from the purchasing store and deliver the product to the user.

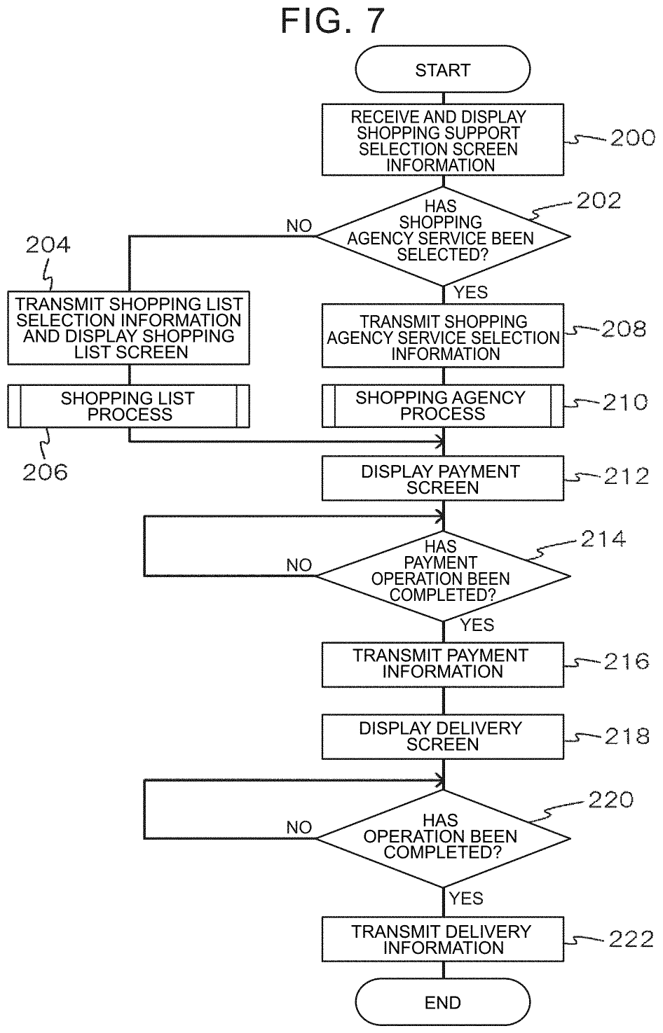

FIG. 7 is a flowchart showing an example of a processing flow performed by the client terminal 18 of the shopping support system 10 according to the present embodiment. The process of FIG. 7 is assumed to start when a store where the shopping agency service is available is selected on the store selection screen 34 described above.

In step 200, the CPU 18A receives the shopping support selection screen information from the shopping support server 12, displays the shopping support selection screen 36 on the display unit 18F, and proceeds to step 202.

In step 202, the CPU 18A determines whether the shopping agency service has been selected. In the determination, it is determined whether the operation of selecting the “Shopping agency service” on the shopping support selection screen 36 is performed by the operation unit 18E. When the shopping agency service has not been selected, the process proceeds to step 204, and when the shopping agency service has been selected, the process proceeds to step 208.

In step 204, the CPU 18A transmits the shopping list selection information, displays the shopping list screen 42, and proceeds to step 206. Specifically, the shopping list selection information indicating that the shopping list is selected is transmitted to the shopping support server 12, and the shopping list screen 42 is displayed based on the shopping list screen information transmitted from the shopping support server 12.

In step 206, the CPU 18A performs shopping list process and proceeds to step 212. In the shopping list process, a process of receiving shopping support using the shopping list by the shopping support server 12 is performed. For example, in the shopping list process, the shopping list screen information for displaying the shopping list screen 42 is acquired from the shopping support server 12 and the shopping list screen 42 is displayed. Further, the user performs an operation of selecting a product to be purchased in the shopping list displayed on the shopping list screen 42, and the operation information is transmitted to the shopping support server 12. The shopping list process proceeds to step 212 when the operation of selecting “Proceed to checkout” on the shopping list screen 42 is performed.

On the other hand, in step 208, the CPU 18A transmits the shopping selection information indicating that the shopping agency service has been selected to the shopping support server 12, and proceeds to step 210.

In step 210, the CPU 18A performs shopping agency process and proceeds to step 212. In the shopping agency process, the shopping agency operator performs a process of performing shopping on behalf of the user while displaying the streaming video on the display unit 18F and talking. For example, in the shopping agency process, the streaming screen information for displaying the streaming screen 38 is received from the shopping support server 12 and displayed on the display unit 18F. In addition, a talking process is performed to inform the shopping agency operator of the product to be purchased while watching the streaming video. The shopping agency process proceeds to step 212 when the operation of selecting “Proceed to checkout” on the streaming screen 38 is performed.

In step 212, the CPU 18A displays the payment screen 44 on the display unit 18F and proceeds to step 214. That is, the payment screen information for displaying the payment screen 44 transmitted by the shopping support server 12 in the above step 112 is received and displayed on the display unit 18F.

In step 214, the CPU 18A determines whether the payment operation has been completed. In the determination, it is determined whether an operation of selecting a payment method is performed on the payment method selection menu displayed on the payment screen 44 and an operation of selecting “Payment & delivery” on the payment screen 44 is performed. The process waits until it is determined that the payment operation has been completed and proceeds to step 216.

In step 216, the CPU 18A transmits the payment information indicating the payment method selected from the payment method selection menu displayed on the payment screen 44 to the shopping support server 12, and proceeds to step 218. Accordingly, the shopping support server 12 determines that the payment information has been received in step 114 described above.

In step 218, the CPU 18A displays the delivery screen 46 on the display unit 18F and proceeds to step 220. That is, the delivery screen information transmitted from the shopping support server 12 in step 116 described above is received and the delivery screen 46 is displayed on the display unit 18F.

In step 220, the CPU 18A determines whether the operation on the delivery screen 46 has been completed. In the determination, it is determined whether the input of the delivery destination, the time zone, and the like has been completed on the delivery screen 46 and the operation of selecting “Start delivery” has been performed. The process waits until it is determined that the operation on the delivery screen 46 has been completed, and proceeds to step 222.

In step 222, the CPU 18A transmits the delivery information such as the delivery destination and the time zone input to the delivery screen 46 to the shopping support server 12 to end the series of processes.

By performing the processes in this way, the shopping method using the shopping agency service through streaming distribution and the shopping method using the shopping list generated from the purchase history of the user are prioritized from among the plurality of shopping methods and displayed on the user's client terminal 18. When the shopping method using the shopping agency service is selected, the process of streaming distributing the image of the product candidate to the user and receiving the purchase instruction from the user is performed. When the shopping method using the shopping list is selected, the process of receiving the purchase instruction of the product selected from the shopping list is performed. As a result, it is possible to provide optimized shopping support to users who are unfamiliar with normal online shopping on a website screen or who have a fixed number of products that they often purchase for many years.

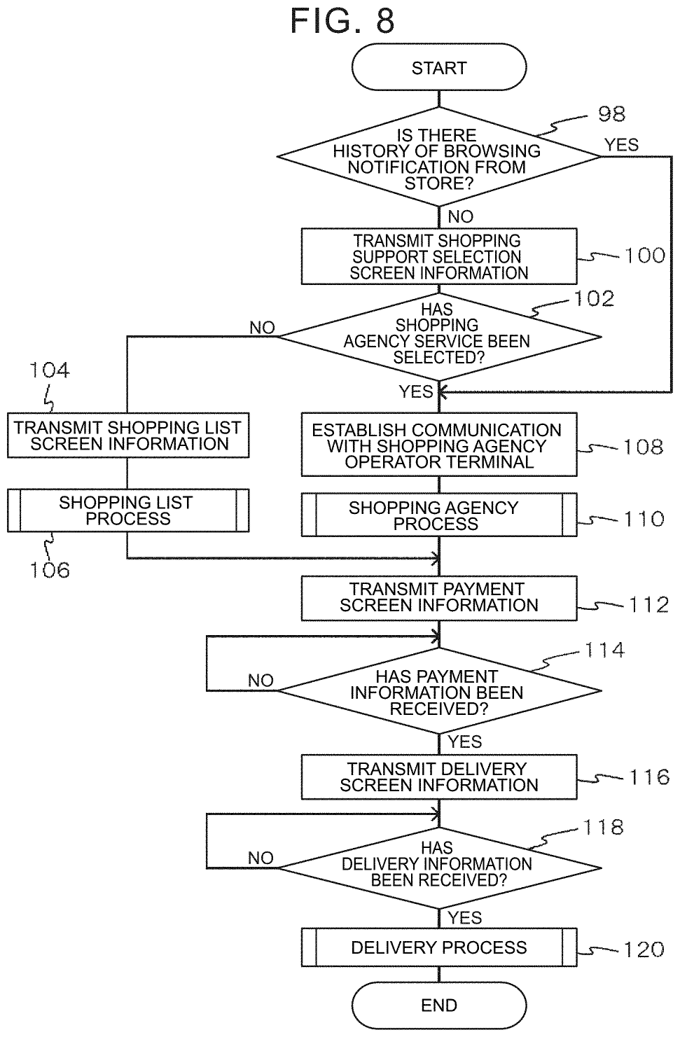

In the above embodiment, when a store is selected on the store selection screen 34, the shopping support selection screen 36 is displayed so that the user can select “Shopping agency service” or “Shopping list”. However, any of “Shopping agency service” or “Shopping list” may be automatically selected according to a predetermined condition. For example, when a user browses product notifications from a store, the user is likely to be interested in products other than those in the shopping list, and is more likely to select the shopping method using “Shopping agency service”. Therefore, when the user selects a store after browsing notifications from a store such as “Today's flyer” shown in FIG. 3, advertisements for special sales, and notifications of recommended products, “Shopping agency service” may be automatically selected. This makes it possible to save the trouble of the user who selects “Shopping agency service”. Specifically, as shown in FIG. 8, step 98 is added to the start of the process of FIG. 6. FIG. 8 is a flowchart showing a modified example of a processing flow performed by the shopping support server 12 of the shopping support system 10 according to the present embodiment.

That is, when a store is selected on the store selection screen 34, the process of FIG. 8 is started. In step 98, it is determined whether there is a history of browsing the notification from the store. In the determination, it is determined, for example, whether there is a history of browsing “Today's information” on the initial screen 30 or “Today's flyer” on the store selection screen 34. When it is determined that there is a history of browsing the notification from the store, the process proceeds to step 108, and thereafter, the same process as that of FIG. 6 is performed. When it is determined in step 98 that there is no history of browsing the notification from the store, the process proceeds to step 100 and the same process as in the above embodiment is performed.

As for the process of the client terminal 18, when there is a history of browsing the notification from the store, the process of steps 200 to 208 of FIG. 7 may be omitted and the process may be started from step 210.

In the above embodiment, the shopping support server 12, the product management server 14, and the delivery management server 16 have been described as separate servers, but the present disclosure is not limited to this. For example, two of the three server functions may be provided in one server to constitute two servers, or a single server having the functions of three servers may be provided. Further, the shopping support system 10 may include a server other than the above.

Further, in the above embodiment, the shopping support server 12 has been described as the shopping support device, but the client terminal 18 may be regarded as the shopping support device.

In the above embodiment, the process performed by each of the shopping support server 12 and the client terminal 18 is not limited to this. For example, a part of the process performed by the shopping support server 12 may be performed on the client terminal 18 side. Alternatively, a part of the process performed by the client terminal 18 may be performed on the shopping support server 12 side.

The process performed in each component of the shopping support system 10 in each of the above embodiments has been described as software processing performed by executing a program, but the present disclosure is not limited to this. For example, the process may be performed by hardware such as a graphics processing unit (GPU), an application specific integrated circuit (ASIC), and a field-programmable gate array (FPGA). Alternatively, the process may be performed by a combination of both software and hardware. Further, in the case of software processing, the program may be stored in various storage media and distributed.

Furthermore, the present disclosure is not limited to the above, and it goes without saying that the present disclosure can be variously modified and implemented within the scope thereof

What is claimed is:

1. A shopping support device comprising:
a display processing unit that performs a process of preferentially displaying a first shopping method using streaming distribution and a second shopping method using a shopping list generated from a purchase history of a user from among a plurality of shopping methods; and
a processing unit that performs a process of streaming distributing an image of a product candidate to the user and receiving a purchase instruction from the user when the first shopping method displayed by the display processing unit is selected, and that performs a process of receiving a purchase instruction for a product selected from the shopping list when the second shopping method is selected.

2. The shopping support device according to claim 1, wherein the display processing unit displays two options of the first shopping method and the second shopping method.

3. The shopping support device according to claim 1, wherein when the display processing unit performs display after the user browses a notification related to a product from a store, the display processing unit performs a process of preferentially displaying the first shopping method over the second shopping method.

4. The shopping support device according to claim 1, wherein the processing unit receives delivery information for delivery to the user, and further performs a process related to arrangement of the delivery to the user.

5. A shopping support system comprising:
the shopping support device according to claim 1;
a client terminal for the user to shop, the client terminal including an operation unit for operation of selecting the first shopping method or the second shopping method and a display unit for performing display by the display processing unit;
a shopping agent terminal for a shopping agent to perform shopping on behalf of the user, the shopping agent terminal including an imaging unit for capturing an image for the streaming distribution and a voice input and output unit for talking with the user; and
a delivery management device that manages the delivery of a product subjected to the purchase instruction received by the shopping support device.

6. A shopping support method executed by a computer, the shopping support method comprising:
preferentially displaying a first shopping method using streaming distribution and a second shopping method using a shopping list generated from a purchase history of a user from among a plurality of shopping methods;
performing a process of streaming distributing an image of a product candidate to the user and receiving a purchase instruction from the user when the displayed first shopping method is selected; and
performing a process of receiving the purchase instruction of a product selected from the shopping list when the second shopping method is selected.

7. A shopping support program for causing a computer to function as each unit of the shopping support device according to claim 1.
